(19) United States
(12) Patent Application Publication
(10) Pub. No.: US 2026/0177175 A1
(43) Pub. Date: Jun. 25, 2026

(54) FEMALE ELEMENT FOR A FLUIDIC CONNECTOR, AND ASSOCIATED FLUIDIC CONNECTOR

(71) Applicant: STAUBLI FAVERGES, Faverges-Seythenex (FR)

(72) Inventors: Fabrice Golfier, Pallud (FR); Christophe Durieux, Gilly sur Isere (FR)

(21) Appl. No.: 19/422,997

(22) Filed: Dec. 17, 2025

(30) Foreign Application Priority Data
Dec. 23, 2024 (FR) 2415087

(51) Int. Cl. F16L 37/086; F16L 37/12; F16L 37/28; F16K 24/06

(52) U.S. Cl. CPC F16L 37/086; F16L 37/1215; F16L 37/28; F16K 24/06

(57) ABSTRACT

This female element for a fluidic connector is designed to be connected to a Schrader-type male fitting, with a threaded tubular part. The female element include a main body, which provides a distal mouth for receiving the male fitting in an engaged position, and an adapter, which is intended to be secured to a pipeline, and which is assembled to the main body. A lock, which is received in a housing provided radially in the main body, provides a through opening intended to receive the male element in an engaged position. A lock stop is guided in the main body and extends in the housing and in the opening of the lock, so as to allow the movements of the lock between a locking position and an unlocking position, while preventing movements beyond the locking position.

### FIELD

This invention relates to a female element for a fluidic connector, as well as a fluidic connector comprising such a female element.

### BACKGROUND

We are interested here in female elements configured to be fluidically connected to a Schrader-type male fitting, also called a "Schrader fitting." Schrader fittings, named after their inventor, are widely used on automotive vehicle wheels to allow tire inflation and are, for example, defined in ISO 3877-2:1997. A Schrader fitting includes a threaded tubular part with an internal passage that is sealed by a valve under pressure. This valve includes a pin that extends towards the mouth of the fitting and is arranged to be pushed by the female element when connecting the female element to the male fitting, thus allowing air passage. By extension, a "Schrader connector" also refers to a female element designed to be connected to a Schrader-type male fitting.

FR 2 474 639-A1 discloses an example of a female element for a Schrader fitting, this female element including a claw 5 with a tooth 403 capable of penetrating the external threading of the male fitting. The claw is radially mounted on the body of the female element and is radially movable between a locked position and an unlocked position thanks to a lever 6. This construction is relatively simple but remains relatively fragile and radially bulky, with the lever tail being particularly exposed to shocks.

This invention aims to address these problems by proposing a female element for a Schrader fitting that is both compact and robust.

### SUMMARY

To this end, the invention relates to a female element for a fluidic connector, the female element being designed to be connected to a Schrader-type male fitting, the male fitting comprising a tubular part with threading and housing a valve with a valve opening pin, the female element comprising:

a main body, which comprises a first passage extending along a longitudinal axis, the main body comprising a distal portion and a proximal portion, which are aligned along the longitudinal axis, the first passage opening from the distal portion through a distal mouth, the main body being configured to receive the male fitting in the first passage through the distal mouth, the male fitting being in an engaged position relative to the female element, the distal portion comprising a housing, which extends from the outside of the main body along a locking axis radial to the longitudinal axis and which opens into the first passage,

an adapter, which is traversed by a second passage, and which comprises:

a proximal part, from which the second passage opens and which comprises securing means, which are intended for the fluidic connection of the adapter to a pipeline,

an intermediate part, which comprises assembly means, by which the adapter is able to be assembled to the proximal portion of the main body, in an assembled configuration of the female element,

a distal part, which comprises a pusher, the pusher extending, in the first passage, from the intermediate part towards the distal mouth when the female element is in an assembled configuration, the second passage opening from the pusher, so that when the adapter is assembled to the main body, the first passage and the second passage together form an internal channel of the female element, the pusher being able to push the pin of the male fitting when connecting the male fitting to the female element,

a lock, which is assembled to the distal portion, and which comprises:

a locking portion, which is received in the first passage and wherein an opening is provided, which extends along an opening axis, and which defines a passage ring for the male fitting in an engaged position,

a retaining relief, which extends protruding into the opening, and which is able to penetrate the threading of the male fitting,

an actuation surface opposite the retaining relief relative to the opening axis,

the lock being received in the housing and being translatable relative to the main body along the locking axis, between:

a locking position, wherein, when the male fitting is received in the distal mouth in an engaged position, the retaining relief penetrates the threading of the male fitting to maintain the male fitting in an engaged position, and

an unlocking position, wherein the retaining relief releases the threading of the male fitting and does not oppose the withdrawal of the male fitting from the main body,

a return member, which is configured to return the lock from its unlocking position to its locking position,

an annular seal, which is arranged around the pusher in contact with an axial surface of the adapter, the axial surface being oriented towards the distal mouth and being carried by a plane perpendicular to the longitudinal axis, the annular seal being configured to cooperate with the tubular part of the male fitting in an engaged position to ensure sealing between the male fitting and the adapter,

wherein:

the female element also comprises a lock stop, the lock stop comprising:

an annular distal part, which is guided in the main body and which extends, along the longitudinal axis, in the housing of the main body and in the opening of the lock, the annular distal part cooperating with the locking portion to allow the movements of the lock between the locking position and the unlocking position, while preventing movements beyond the locking position, and,

an internal bore, which surrounds the pusher and which is intended to receive the tubular part of the male fitting,

the annular seal is placed between the internal bore of the lock stop and the pusher.

By means of the invention, the female element, once connected to the Schrader-type fitting, ensures good sealing because the male fitting is guided by the internal bore of the lock stop, while being supported on the annular seal, whose sealing surface is formed by the internal bore of the lock stop.

According to advantageous but non-mandatory aspects of the invention, such a female element can incorporate one or more of the following features taken individually or in any technically permissible combination:

The annular distal part of the lock stop extends, along the longitudinal axis, beyond the locking axis, while a diameter of the internal bore of the annular distal part is slightly larger than an external diameter of the tubular part of the male fitting.

The lock provides an actuation surface, which is accessible from the outside of the female element and which is intended for a user to move the lock from the locking position to the unlocking position, against the return member, while the lock housing communicates with the outside of the main body through an additional hole, which is provided through the main body and which is located opposite the actuation surface relative to the longitudinal axis.

The retaining relief comprises a first tooth, which reproduces a complementary threading portion of the threading of the tubular part of the male fitting, the first tooth extending over an angular portion greater than 60° centered on the opening axis.

The retaining relief comprises, in addition to the first tooth, at least one second tooth, which is able to penetrate the threading of the tubular part of the male fitting jointly with the first tooth, while each second tooth reproduces a complementary threading portion of the threading of the tubular part, extending over an angular portion greater than 60° centered on the opening axis.

The return member is located on the side of the actuation surface relative to the longitudinal axis and acts along a return axis, which is parallel to the locking axis, and which is located between the locking axis and the rear of the main body.

The lock provides a primary support surface, which extends generally along a plane orthogonal to the locking axis, while the main body provides a secondary support surface, which is located opposite the primary support surface, and the return member acts between the primary support surface of the lock and the secondary support surface.

The lock provides a primary support surface, which extends generally along a plane orthogonal to the locking axis, while the female element comprises a support, which is received in the housing of the main body, the support being traversed by the annular distal part of the lock stop, that the support provides a secondary support surface, which is located opposite the primary support surface, and that the return member acts between the primary support surface of the lock and the secondary support surface.

The lock provides a primary support surface, which extends generally along a plane orthogonal to the locking axis, while the lock stop provides a secondary support surface, which is located opposite the primary support surface, and that the return member acts between the primary support surface of the lock and the secondary support surface.

The lock comprises an insert, which is made of metal and which, when the female element is in an assembled configuration, is integral with the rest of the lock and is arranged on the side of the distal mouth, while the insert provides a passage ring for the male fitting, the passage ring forming a portion of the lock opening, and that the insert provides the retaining relief.

The lock presents a stop face, which is oriented towards the distal mouth and which is axially aligned with the internal bore of the lock stop when the lock is in the locking position, while the lock and the main body are designed so that when the lock is in its locking position and the male fitting is disconnected from the female element, the stop face opposes the introduction of the male fitting into the through opening of the lock.

The invention also relates to a fluidic connector, comprising: an example of the female element as described above, and a Schrader-type male fitting, the male fitting comprising a tubular part with threading and housing a valve with a valve opening pin, wherein the male fitting is received in an engaged position in the internal channel of the female element.

### BRIEF DESCRIPTION OF THE DRAWINGS

The invention will be better understood, and other advantages thereof will appear more clearly in light of the following description of several embodiments of a female element and a fluidic connector, in accordance with its principle, given solely by way of example and made with reference to the appended drawings, wherein:

FIG. 1 is a longitudinal section of a fluidic connector according to a first embodiment of the invention and shown in a disconnected configuration, the fluidic connector comprising a female element, also in accordance with the invention;

FIG. 2 is an exploded perspective view of the female element shown in FIG. 1;

FIG. 3 is a longitudinal section of the fluidic connector shown in FIG. 1, shown in an engaged configuration;

FIG. 4 is a longitudinal section of the fluidic connector shown in FIG. 1 in an engaged configuration, according to a section plane IV-IV in FIG. 3;

FIG. 5 is a broken section of the fluidic connector shown in FIG. 3, according to a plane V-V marked in FIG. 3;

FIG. 6 is a longitudinal section of a fluidic connector according to a second embodiment of the invention and shown in the engaged configuration, the fluidic connector comprising a female element, also in accordance with the invention;

FIG. 7 is a longitudinal section of the fluidic connector shown in FIG. 6, according to a section plane VII-VII in FIG. 6;

FIG. 8 is an exploded perspective view of the female element shown in FIG. 6;

FIG. 9 respectively shows, on two inserts a) and b), a longitudinal section of a female element belonging to a fluidic connector according to a third embodiment of the invention, and a broken section of the female element of insert a), according to a plane IX IX;

FIG. 10 is an exploded perspective view of the female element shown in FIG. 9;

FIG. 11 respectively shows, on two inserts a) and b), a longitudinal section of a female element belonging to a fluidic connector according to a fourth embodiment of the invention, and a broken section of the female element of insert a), according to a plane XI-XI;

FIG. 12 is an exploded perspective view of the female element shown in FIG. 11; and

FIG. 13 is a longitudinal section of a female element belonging to a fluidic connector according to a fifth embodiment of the invention.

### DETAILED DESCRIPTION

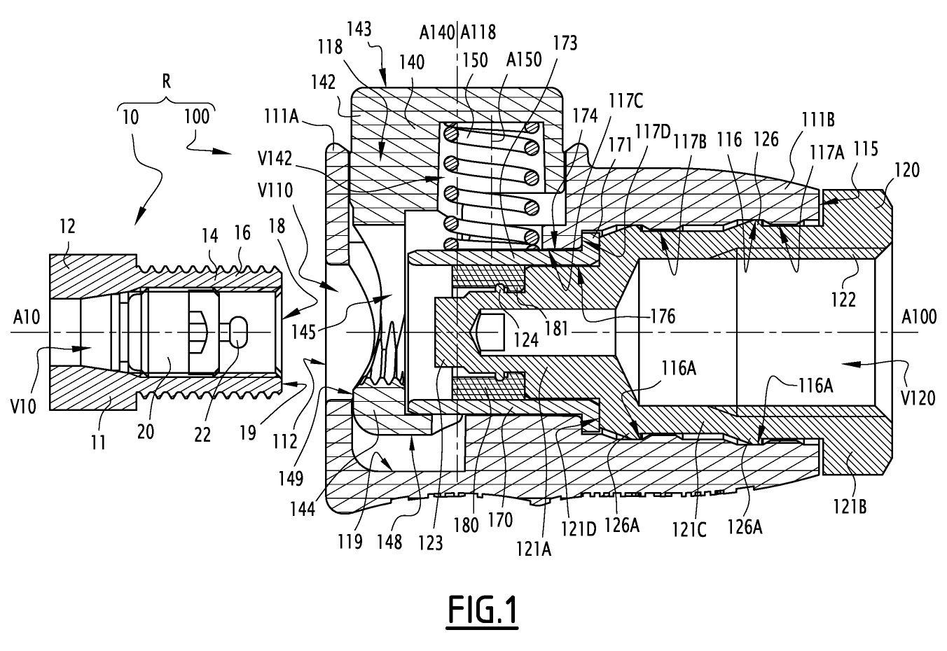

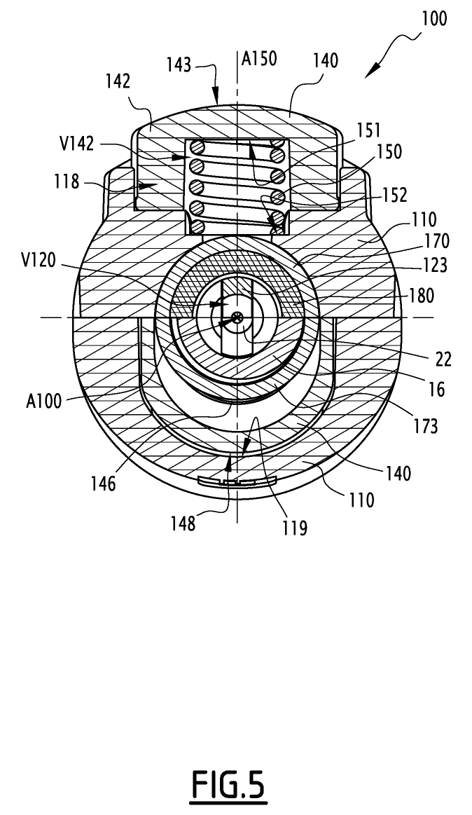

A fluidic connector R, in accordance with a first embodiment of the invention, is described with reference to FIGS. 1 to 5. The fluidic connector R comprises a male fitting 10, which is located on the left of FIG. 1, and a female element 100, located on the right of FIG. 1. The following description is made in relation to the various elements of the fluidic connector R as shown in the figures, knowing that it may be otherwise in reality.

The fluidic connector R is shown in a disconnected configuration in FIG. 1, the male fitting 10 being located opposite the female element 100. In the disconnected configuration, for each of the elements chosen from the female element 100 and the male fitting 10, a distal side - or front side - of this element is the side closest to the other element, while a proximal side - or rear side - of this element is the side furthest from the other element. Thus, in FIG. 1 the distal side of the male fitting 10 is located on the right, opposite the female element 100, while the proximal side of the male fitting 10 is located on the left. Symmetrically, in FIG. 1 the distal side of the female element 100 is located on the left, opposite the male fitting 10, while the proximal side of the female element 100 is located on the right.

The male fitting 10, which is also simply called fitting, or sometimes "connector," comprises a male body 11 that has a hollow tubular shape and that provides an internal passage V10 extending along a main axis A10. The male body 11 comprises a proximal part 12, through which the internal passage V10 opens, and which is generally configured to be secured with an inner tube, or even directly with a rim in a tubeless configuration. The inner tube or rim is not shown. The male body 11 comprises a distal part 14, which presents, on an external side opposite the internal passage V10, a threaded tubular part 16. The internal passage V10 opens from the distal part 14 through a distal mouth 18. The distal part 14 presents an end face 19, which defines the distal mouth 18. The end face 19 here has a ring shape and is geometrically carried by a plane orthogonal to the main axis A10. The end face 19 is therefore an axial face.

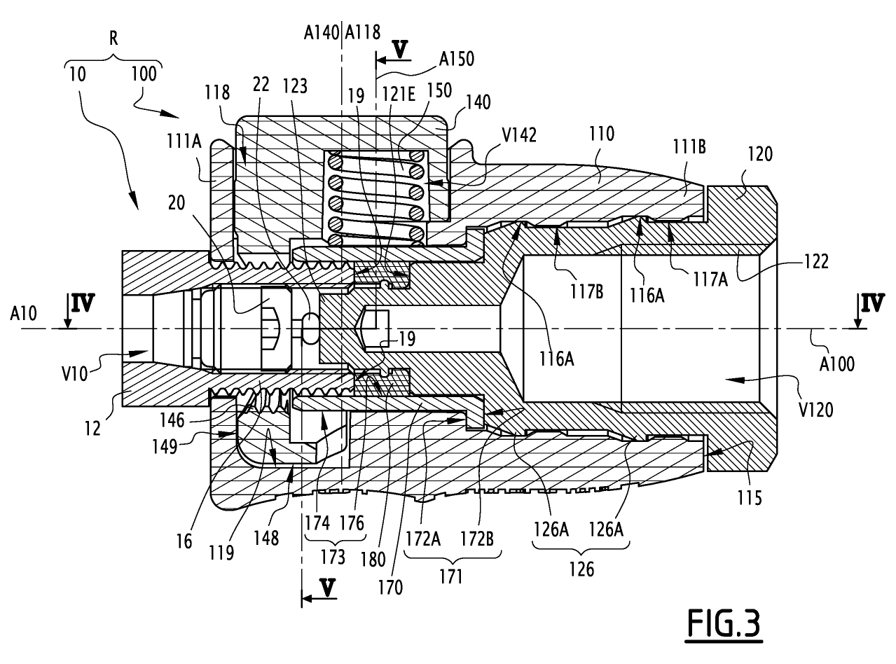

The distal part 14 of the male fitting 10 is intended to be received in the female element 100, as shown in FIG. 3, the male fitting 10 then being in an engaged position relative to the female element 100.

The male fitting 10 also comprises a valve 20, which is received in the internal passage V10. The valve 20 is translatable relative to the male body 11 between a closed position, wherein the valve 20 seals the internal passage V10 in a leak-tight manner, and an open position, wherein the valve 20 allows air circulation in the internal passage V10. In the closed position, the valve 20 is closer to the distal mouth 18 than in the open position. The open and closed positions are longitudinal positions along the main axis A10. When the proximal part 12 is fluidically connected to a pressurized element, the air pressure tends to push the valve 20 towards the closed position.

The valve 20 comprises a rod, called pin 22, which extends from the rest of the valve 20 towards the distal mouth 18. The pin 22 here has a rounded end. When the pin 22 is moved towards the proximal side of the male fitting 10, in other words towards the rear of the male fitting 10, the pin 22 moves the valve 20 from the closed position to the open position, allowing air circulation through the internal passage V10.

We now describe the female element 100. The female element 100 extends generally along a longitudinal axis A100 and provides an internal channel V100. When the fluidic connector R is in a connected configuration, the internal channel V100 of the female element 100 is in fluidic communication with the internal passage V10 of the male fitting 10, the main axis A10 being aligned with the longitudinal axis A100.

The female element 100 comprises a main body 110, which is traversed by a first passage V110, and an adapter 120, which is traversed by a second passage V120 and which is assembled to the main body 110 in an assembled configuration of the female element 100, so that the second passage V120 is in communication with the first passage V110, the first passage V110 and the second passage V120 together forming the internal channel V100 of the female element 100. In other words, the first passage V110 and the second passage V120 each form a portion of the internal channel V100. The first passage V110 and the second passage V120 each extend along the longitudinal axis A100.

The adapter 120 comprises: a distal part 121A, from which the second passage V120 opens and which provides a pusher 123 able to push the pin 22 of the male fitting 10 in an engaged position. a proximal part 121B, from which the second passage V120 opens and which includes securing means 122 with a pipeline. The pipeline is not shown. In other words, the adapter 120 is able to be fluidically connected to a pipeline, so that the second passage V120 is in fluidic communication with the pipeline. an intermediate part 121C, which is interposed between the distal part 121A and the proximal part 121B, the intermediate part 121C radially delimiting the second passage V120 and comprising assembly means 126, which are intended for the assembly of the adapter 120 with the main body 110.

In the illustrated example, the adapter 120 provides a distal face 121D, which connects, on an external side of the adapter, the intermediate part 121C to the distal part 121A. The distal face 121D is an axial face, which is geometrically carried by a transverse plane, i.e. a plane orthogonal to the longitudinal axis A100. The distal face 121D is oriented towards the front of the adapter 120, i.e. towards the distal side of the adapter 120.

The distal part 121A also provides an axial surface 121E, which is here located between the distal face 121D and the pusher 123. The axial surface 121E is oriented towards the distal mouth 112 and is carried by a plane perpendicular to the longitudinal axis A100. Thus, the axial surface 121E is located behind the pusher 123, particularly behind the place where the second passage V120 opens.

In the non-limiting illustrated example, the securing means 122 to the pipeline are formed by a threaded bore. In a non-illustrated variant, the securing means have a different shape, for example a barbed tail intended to receive a flexible hose held by a clamp, etc.

In the non-limiting illustrated example, the assembly means 126 comprise at least one collar 126A, preferably two collars 126A, which are provided protruding on an external side of the intermediate part 121C. The two collars 126A are here provided at a distance from each other along the longitudinal axis A100. The two collars 126A here have a conical face, which diverges towards the rear of the adapter 120, and a stop face, which is carried by a plane orthogonal to the longitudinal axis A100 and which is oriented towards the rear of the adapter 120.

The main body 110 comprises a distal portion 111A and a proximal portion 111B, which are aligned along the longitudinal axis A100. The first passage V110 opens from the distal portion 111A through a distal mouth 112. The main body 110 is configured to receive the male fitting 10 in the first passage V110 through the distal mouth 112. The male fitting 10 is then in the engaged position relative to the female element 100.

The proximal portion 111B of the main body 110 includes a bore 114, which is configured to receive the distal part 121A and the intermediate part 121C of the adapter 120 when the female element 100 is in the assembled configuration.

The first passage V110 is thus radially delimited by the bore 114. The proximal portion 111B here provides an end surface 115, which is an axial surface, i.e. a surface carried by a plane orthogonal to the longitudinal axis A100. The proximal portion 111B comprises an internal side, which is oriented towards the longitudinal axis A100, and an external side, which is oriented opposite the internal side. The proximal portion 111B comprises complementary assembly means 116, which are intended for the assembly of the adapter 120 to the main body 110. More precisely, the assembly means 126 of the adapter 120 are intended to cooperate, notably by shape complementarity, with the complementary assembly means 116, for the assembly of the adapter 120 to the main body 110.

The complementary assembly means 116 comprise at least one internal groove 116A, preferably two internal grooves 116A, which are provided recessed in the bore 114. Each internal groove 116A is generally carried by a plane orthogonal to the longitudinal axis A100, in other words each internal groove 116A is a radial groove to the longitudinal axis A100. Each internal groove 116A extends over 360° around the longitudinal axis A100 and thus forms an internal circumferential groove. Each internal groove 116A is intended to receive a respective collar 126A. The main body 110 is here made of a synthetic polymer material, preferably manufactured by hot injection. Preferably, the adapter 120 is made of metal.

Preferably, the bore 114 of the proximal portion 111B comprises, on the internal side and moving from the end surface 115 towards the distal mouth 112: a first cylindrical portion 117A, which has a first internal diameter, and which is intended to receive the intermediate part 121C of the adapter 120, a second cylindrical portion 117B, which has a second internal diameter, the second internal diameter being less than or equal to the first internal diameter, a third cylindrical portion 117C, which has a third internal diameter, the third internal diameter being less than the second internal diameter, a stop wall 117D, which extends in a plane perpendicular to the longitudinal axis A100 between the second cylindrical portion 117B and the third cylindrical portion 117C. In other words, the stop wall 117D is an axial wall. The stop wall 117D is oriented towards the rear of the main body 110, in other words towards the proximal side of the main body 110. The stop wall 117D of the main body 110 is advantageously located opposite the distal face 121D of the adapter 120.

In the illustrated example, one of the two internal grooves 116A is provided in the first cylindrical portion 117A, the other of the two internal grooves 116A being provided in the second cylindrical portion 117B.

The female element 100 also comprises a lock 140, which is intended to maintain the male fitting 10 in an engaged position. The lock 140 is here made of a synthetic polymer material, preferably manufactured by hot injection. The lock 140 is assembled to the distal portion 111A of the main body 110, the lock 140 being movable between: a locking position, wherein, when the male fitting 10 is received in the distal mouth 112 in an engaged position, the lock 140 cooperates with the threading of the tubular part 16, to maintain the male fitting 10 in an engaged position, and an unlocking position, wherein the lock 140 does not cooperate with the threading of the tubular part 16 and does not oppose the withdrawal of the male fitting 10 from the main body 110, as illustrated in FIG. 3.

The female element 100 also comprises a return member 150, which is configured to return the lock 140 from its unlocking position to its locking position. The return member 150 is here a compression spring, which acts between the lock 140 and the rest of the female element 100. More precisely, the return member 150 acts between a primary support surface 151, which is provided on the lock 140, and a secondary support surface 152, which is provided on the rest of the female element 100 and which is located opposite the primary support surface 151.

In the illustrated example, the lock 140 is partially received in the first passage V110. The main body 110 provides for this purpose a housing 118, which extends along a locking axis A118, which is here a radial axis to the longitudinal axis A100, from the outer surface of the main body 110 to a bottom 119. The first passage V110 opens from the main body through the housing 118. In the first embodiment of the invention, the housing 118 is preferably blind, the housing 118 having a bottom 119.

In the illustrated example, the lock 140 comprises an actuation portion 142, which provides an actuation surface 143, the actuation surface being a surface accessible from the outside of the female element 100 and being intended for a user to move the lock 140 from the locking position to the unlocking position, against the return member 150. The actuation surface 143 here has a normal generally perpendicular to the longitudinal axis A100. In other words, the actuation surface 143 is a radial surface, oriented centrifugally to the longitudinal axis A100. The actuation portion 142 here has a generally cylindrical shape with a circular section, and extends along a lock axis A140, which is parallel to the locking axis A118. In the described example, the lock 140 has a cylindrical shape with a circular section, and the lock axis A140 is coincident with the axis of the cylinder containing the lock 140. In an unrepresented alternative, the lock has a non-circular section in a plane perpendicular to the locking axis A118. The lock axis A140 then passes through a barycenter of the section of the lock 140.

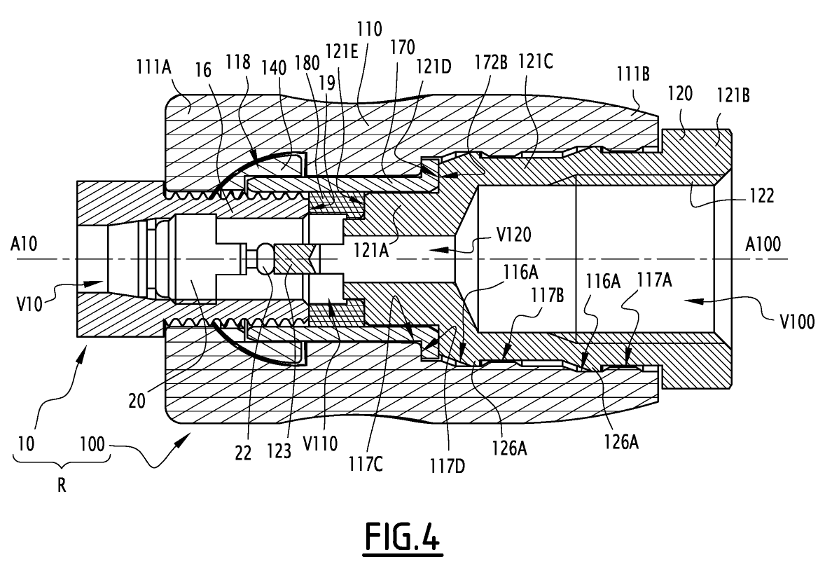

The lock 140 also comprises a locking portion 144, which has a generally cylindrical shape, extending along the lock axis A140, with preferably a non-circular section. In the illustrated example, the locking portion 144 has a section in a portion of a circle, particularly in a semicircle, as illustrated in section in FIG. 4. When the locking portion 144 is received in the housing 118, the lock 140 is received in the housing 118, the lock axis A140 is coincident with the locking axis A118. The lock 140 is then guided in translation relative to the main body 110, the locking and unlocking positions being two axial positions of the lock 140 along the locking axis A118.

The return member 150 acts along a return axis A150, which is advantageously parallel to the locking axis A118. The return axis A150 is here located on the opposite side of the distal mouth 112 relative to the locking axis A118, in other words between the locking axis A118 and the rear of the main body 110. Such an arrangement facilitates the assembly of the female element 100 and allows for radial compactness.

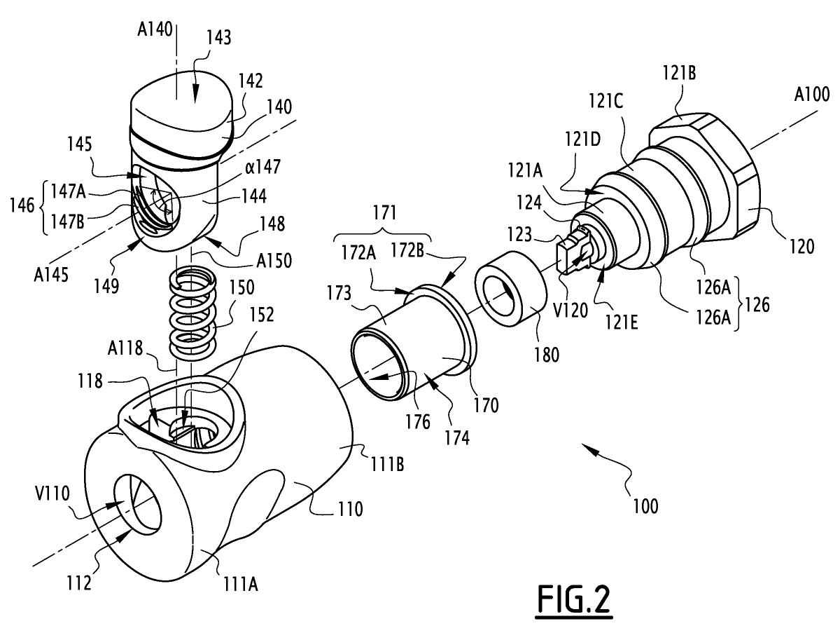

In the first embodiment, the return member 150 is located on the side of the actuation surface 143 relative to the longitudinal axis A100. In other words, the primary support surface 151 and the secondary support surface 152 are each located on the side of the actuation surface 143 relative to the longitudinal axis A100. The actuation portion 142 of the lock 140 is advantageously hollow and provides a housing V142 intended to partially receive the return member 150. The housing V142 has a bottom, which forms the primary support surface 151. The primary support surface 151 is thus a surface opposite the actuation face 143. The secondary support surface 152 is here provided on the main body 110. The secondary support surface 152 is located opposite the primary support surface 151. The secondary support surface 152 is here a surface provided in the housing 118, as illustrated in FIG. 2.

The locking portion 144 provides an opening 145, which is provided through the locking portion 144 along an opening axis A145 orthogonal to the lock axis A140. When the female element 100 is assembled, in a use configuration, the locking portion 144 is received in the first passage V110, the opening 145 of the lock 140 forming a portion of the first passage V110. The opening axis A145 is then parallel to the longitudinal axis A100. The opening 145 of the lock 140 is able to receive the male fitting 10, forming a passage ring for the male fitting 10. In the connected configuration of the fluidic connector R, the distal part 14 of the male fitting 10 passes through the lock 140 through the opening 145 of the lock 140, the threaded tubular part 16 being partially received in the opening 145 of the lock 140.

The locking portion 144 provides a retaining relief 146, which is provided protruding into the opening 145 of the lock 140 and which is configured to cooperate with the threading of the tubular part 16 of the male fitting 10 in an engaged position. The retaining relief 146 is here formed by a threading portion having a complementary shape to the threading of the tubular part 16. When the lock 140 is in the locking position and the male fitting 10 is in the engaged position, the retaining relief 146 cooperates with the threading of the tubular part 16 of the male fitting 10, preventing the male fitting 10 from being moved away from the female element 100. The connector R is then in a connected configuration. When the male fitting 10 is in the engaged position but the lock 140 is in the unlocking position, the connector R is in the engaged configuration.

In the illustrated example, the retaining relief 146 comprises a first tooth 147A, which reproduces a complementary threading portion of the threading of the tubular part 16 of the male fitting 10. The first tooth 147A advantageously extends over an angular portion ?147, centered on the opening axis A145, which is greater than 30°, preferably greater than 60°, for example equal to 60°±5°, preferably still equal to 90°±5°.

Compared to the situation described in FR 2 474 639-A1, a contact surface between the lock in position 140 and the threaded tubular part 16 extends over a much larger angular sector, which reduces the contact pressure and contributes both to the good retention of the male fitting 10 in the engaged position, and to the reduction of wear of the female element 100.

Advantageously, the retaining relief 146 comprises, in addition to the first tooth 147A, at least one second tooth 147B, which is able to penetrate the threading of the tubular part 16 of the male fitting jointly with the first tooth 147A. The second tooth 147B reproduces a complementary threading portion of the threading of the tubular part 16. The second tooth 147B is distant from the first tooth 147A by a thread pitch corresponding to the threading of the tubular part 16 of the male fitting 10. The second tooth 147B has a similar shape, preferably identical, to the first tooth 147A. In particular, the second tooth 147B advantageously extends over an angular portion, centered on the opening axis A145, which is greater than 30°, preferably greater than 60°, for example equal to 60°±5°, preferably still equal to 90°±5°. In the illustrated example, the retaining relief 146 comprises the two teeth 147A/147B, which each have an angular portion greater than 30°, preferably greater than 60°, for example equal to 60°±5°, preferably still equal to 90°±5°. In an unrepresented variant, the retaining relief 146 comprises three or more teeth, which each have an angular portion greater than 30°, preferably greater than 60°, for example equal to 60°±5°, preferably still equal to 90°±5°.

The fact that the retaining relief 146 comprises several teeth 147A/147B increases the lifespan of the female element 100. In particular, when the lock 140 is made of a synthetic polymer material, the wear of the retaining relief 146 is slowed down.

Moreover, as the teeth 147A/147B are complementary threading portions of the threading of the tubular part 16 of the male fitting 10, the rotation of the female element 100 around the longitudinal axis A100 causes the female element 100 to move along the longitudinal axis A100 by screwing or unscrewing effect.

The lock 140 also comprises a lower face 148, which is located opposite the bottom 119 of the housing 118 when the female element 100 is assembled. The lower face 148 is a surface opposite the actuation face 143. The lock 140 advantageously comprises a surface, which connects the lower face 148 to the through opening 145 and which forms a stop face 149, which is oriented towards the distal mouth 112 when the female element 100 is assembled.

The lock 140 and the main body 110 are designed so that when the lock 140 is in the locking position and the male fitting 10 is disconnected from the female element 100, as illustrated in FIG. 1, if the user inserts the male fitting 10 into the female element 100 without moving the lock 140 to the unlocking position, then the end face 19 of the male fitting 10 comes into contact with the stop face 149, which opposes the introduction of the male fitting 10 into the through opening 145 of the lock 140. In other words, when the lock 140 is in the locking position, the distal mouth 112 and the through opening 145 are offset, preventing the introduction of the male fitting 10 into the through opening 145, while when the lock 140 is in the unlocking position, the distal mouth 112 and the through opening 145 are aligned, allowing the introduction of the male fitting 10 into the through opening 145. Without this stop face 149, the operator could forcefully insert the male fitting 10 without actuating the lock 140. The threading of the male fitting 10, which is very aggressive, would then rub on the retaining relief 146 causing wear.

The female element 100 also comprises a lock stop 170, which is received in the internal channel V100, and which is configured to keep the lock 140 captive in the housing 118. The lock stop 170 comprises a proximal collar 171, which here has a ring shape centered on the longitudinal axis A100, the proximal collar 171 comprises a distal face 172A, which is located opposite the stop wall 117D of the main body 110 and by which the lock stop 170 is axially supported against the stop wall 117D of the main body 110, and a proximal face 172B, which is located opposite the distal face 121D of the adapter 120 and by which the lock stop 170 is axially supported against the distal face 121D.

The lock stop 170 also comprises an annular distal part 173, which extends protruding from the proximal collar 171, the annular distal part 173 here having an elongated cylindrical shape, extending along the longitudinal axis A100 and with a circular section. The annular distal part 173 provides an external guiding surface 174, which cooperates with the third cylindrical portion 117C of the main body 110, notably by shape complementarity, so that the annular distal part 173 is guided in the main body 110 and extends, along the longitudinal axis A100, in the housing 118 and in the opening 145 of the lock 140. The annular distal part 173 cooperates with the locking portion 144 to allow the movements of the lock 140 between the locking position and the unlocking position, while preventing movements beyond the locking position. Thus, the lock stop 170 is able to stop the translation of the lock 140 in its locking position. The lock stop 170 is axially supported against the stop wall 117D of the main body 110 and centered in the third cylindrical part 117C of the main body 110.

The annular distal part 173 provides an internal bore 176, which surrounds the pusher 123 and which is intended to receive the tubular part 16 of the male fitting 10 in an engaged position. The annular distal part 173 extends, along the longitudinal axis A100, beyond the lock axis A140. The internal bore 176 has a diameter that is slightly larger than an external diameter of the tubular part 16 of the male fitting 10. By slightly larger, it is meant that the internal bore 176 is configured to receive the tubular part 16 with a reduced dimensional clearance, so as to guide the tubular part 16 during insertion into the bore 176. Typically, a dimensional clearance between 0.1 mm and 0.5 mm is provided.

The female element 100 also comprises an annular seal 180. The annular seal 180 here has a revolution shape around the longitudinal axis A100 with a generally rectangular section in a plane containing the longitudinal axis A100. The annular seal 180 is arranged around the pusher 123, in contact with the axial surface 121E of the adapter 120. Advantageously, lugs 124 are provided protruding on the pusher 123, while the annular seal 180 provides an internal bulge 181, which cooperates with the lugs 124 to keep the annular seal 180 in position around the pusher 123.

The annular seal 180 is thus placed between the internal bore 176 of the lock stop 170 and an external surface of the pusher 123. The annular seal 180 is configured to cooperate, notably by shape complementarity, with the tubular portion 16 of the male fitting 10 in an engaged position, so as to ensure sealing between the male fitting 10 and the adapter 120. More precisely, when the male fitting 10 is in an engaged position, the annular seal 180 is compressed between the end face 19 of the male fitting 10 and the axial surface 121E of the adapter 120, ensuring sealing between the male fitting 10 and the adapter 120.

We now describe an example of assembly of the female element 100.

The assembly of the female element 100 includes the following steps:

Placing the return member 150, here the lock spring, in the housing V142 provided in the lock 140.

Then, placing the lock 140 in the housing 118 provided in the main body 110 and compressing the return member 150, so that the lock 140 is in an intermediate position between the locking position and the unlocking position.

While keeping the return member 150 compressed, inserting the lock stop 170 through the proximal portion 111B of the main body 110, so that the annular distal part 173 extends, along the longitudinal axis A100, in the opening 145 of the lock 140, preventing movements beyond the locking position.

Then, placing the annular seal 180 around the pusher 123 of the adapter 120.

Then, assembling the adapter 120 to the main body 110, by inserting the pusher 123 through the proximal portion 111B of the main body by implementing the assembly means 126, i.e. here until the collars 126A are received in the internal grooves 116A.

We now describe an example of a coupling sequence of the female element 100 to the male fitting 10.

Preferably, the male fitting 10 and the female element 100 are initially in the configuration shown in FIG. 1. To couple the female element 100 and the male fitting 10, the user simply presses the actuation surface 143 of the lock 140 to bring the lock 140 to the unlocking position, aligns the longitudinal axis A100 of the female element 100 with the main axis A10 of the male fitting 10, then brings the female element 100 closer to the male fitting 10.

During the approach, the distal part 14 of the male fitting 10 passes through the distal mouth 112 of the main body 110 and reaches the internal bore 176 of the lock stop 170. The male fitting 10 is then doubly guided, on the one hand by the distal mouth 112 of the main body 110, and on the other hand by the lock stop 170. The end face 19 of the male fitting 10 then reaches the annular seal 180 and compresses the annular seal 180 against the axial surface 121E. The pusher 123 pushes the pin 22 of the male fitting 10, allowing fluid circulation between the female element 100 and the male fitting 10, without any leakage. The fluidic connector R is then in the engaged configuration, as illustrated in FIG. 3.

By releasing the lock 140, the lock 140 moves to the locking position, the retaining reliefs 146 approaching and then cooperating with the external surface of the threaded tubular part 16, preventing the male fitting 10 from being moved away from the female element 100. The connection between the male fitting 10 of the female element 100 is thus locked. The connector R is then in the connected configuration. If necessary, the male fitting 10 can be rotated relative to the female element 100 around the longitudinal axis A100, particularly in a screwing motion, so as to compress the annular seal 180 and eliminate any leaks.

We now describe an example of a decoupling sequence of the female element 100 to the male fitting 10.

The connector R being initially in the connected configuration, in a first step the user actuates the lock 140 by pressing on the actuation surface 143, moving the lock 140 to the unlocking position. The retaining reliefs 146 are then disengaged from the threads of the tubular part 16 of the male fitting 10 and no longer prevent the male fitting 10 from being moved away from the female element 100. As the end face 19 of the male fitting 10 compresses the annular seal 180, the male fitting 10 and the female element 100 move away from each other until the seal is broken. If the fluid is under pressure, the fluid will propagate into the housing 118 and act on the lock 140 to return it to its locking position because the housing 118 is blind. This provides a safety feature that prevents the whip effect resulting from the sudden decompression of the conduit connected to the female element 100.

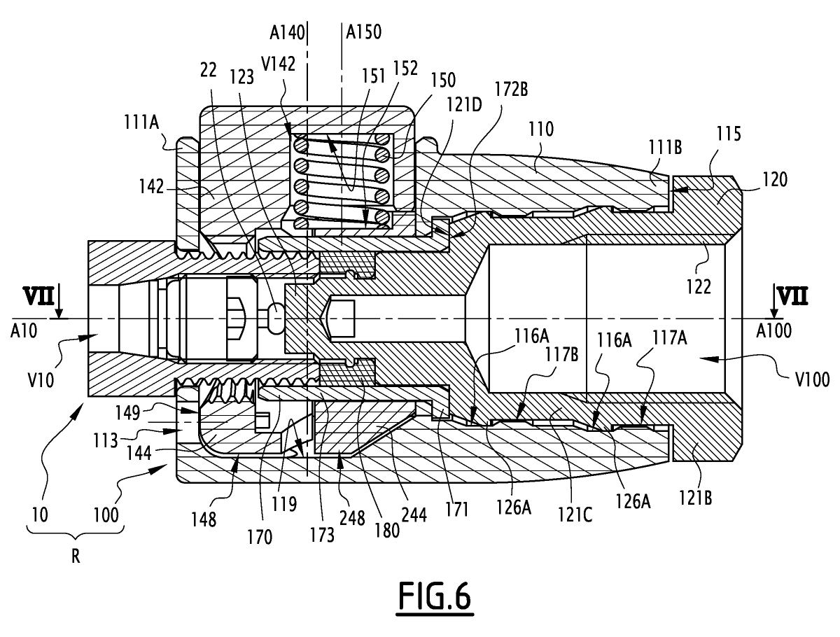

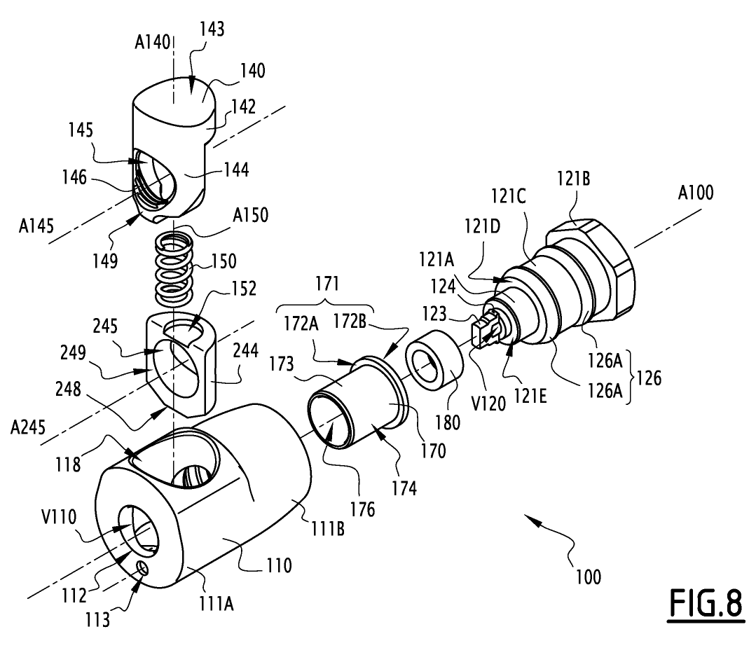

Alternative embodiments of the invention are illustrated in FIGS. 6 to 13. In the alternative embodiments of the invention, elements analogous to those of the other embodiments bear the same references and function in the same way. In the following, we mainly describe the differences between each embodiment and the previous one(s). In relation to the alternative embodiments of the invention, if a reference is mentioned in the description without being shown in a figure, or if this reference is shown in a figure without being mentioned in the description, this reference designates the same element as the one bearing the same reference in the first embodiment.

A second embodiment of the invention is shown in FIGS. 6 to 8. One of the main differences of the second embodiment with the previous embodiment is that the housing 118 provided in the main body 110 is cylindrical with a circular section, while the female element 100 comprises a support 244, which is intended to support the return member 150. The support 244 is received in the housing 118 of the main body 110 jointly with the locking portion 144 and provides the secondary support surface 152. As in the first embodiment, the actuation portion 142 of the lock 140 is hollow and provides the primary support surface 151.

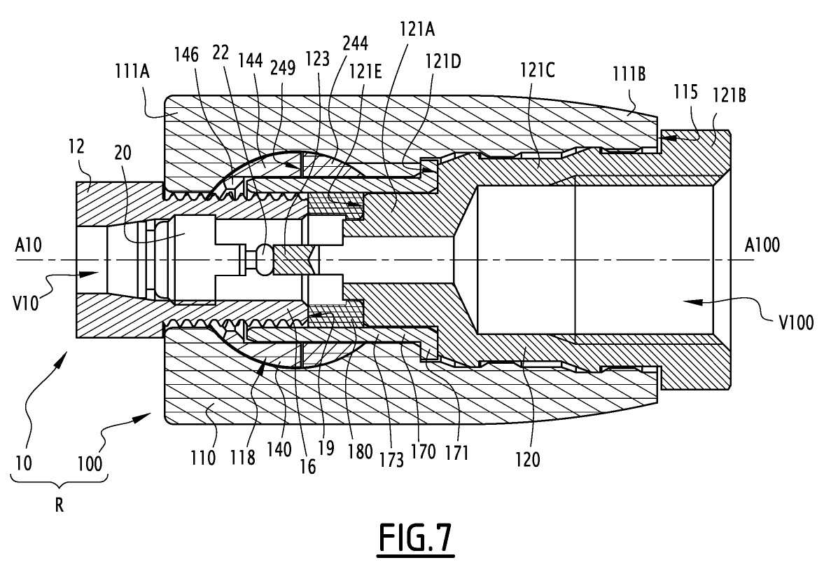

In the illustrated example, the support 244 has a generally cylindrical shape extending along an axis parallel to the lock axis A140. The support 244 has a section in a portion of a circle, which is complementary to the locking portion 144 of the lock 140, as illustrated in section in FIG. 7. The main body 110 of the female element 100 thus has simple shapes, easy to machine with conventional means. It is thus possible to produce the main body 110 in metal, for more durability, at reduced manufacturing costs.

The support 244 provides a secondary opening 245, which is provided through the support 244 along a secondary axis A245, the secondary axis A245 being parallel to the opening axis A145 of the lock 140 when the female element 100 is assembled. The secondary opening 245 is intended to be traversed by the annular distal part 173 of the lock stop 170. In the assembled configuration of the female element 100, the support 244 is received in the housing 118 of the main body 110, the support 244 being traversed by the annular distal part 173, which extends, beyond the secondary opening 245, into the through opening 145 of the lock 140, so as to prevent the movements of the lock 140 beyond the locking position.

The support 244 also comprises a lower face 248, which is located opposite the bottom 119 of the housing 118 when the female element 100 is assembled. The lower face 248 is a surface opposite the secondary support surface 152.

The support 244 is integral with the main body 110 by means of the lock stop 170. The support 244 advantageously provides a front face 249, which extends along a plane orthogonal to the secondary axis A245 and which is intended to guide the locking portion 144 during movements between the locking position and the unlocking position.

The second embodiment of the invention also differs from the first embodiment in that the lock housing 118 communicates with the outside of the main body 110 through an additional hole 113, which is provided through the main body 110 and which is located on a distal face of the main body 110 opposite, relative to the main axis A100, the actuation surface 143 of the lock 140. In the second embodiment, the hole 113 opens on a distal face of the main body 110. Thanks to this hole 113, during disconnection and more particularly when the pressurized fluid propagates into the housing 118, its action on the lock 140 to return it to its locking position is limited. This prevents the operator from having to actuate the lock 140 several times to be able to disconnect the male fitting 10 from the female element 100.

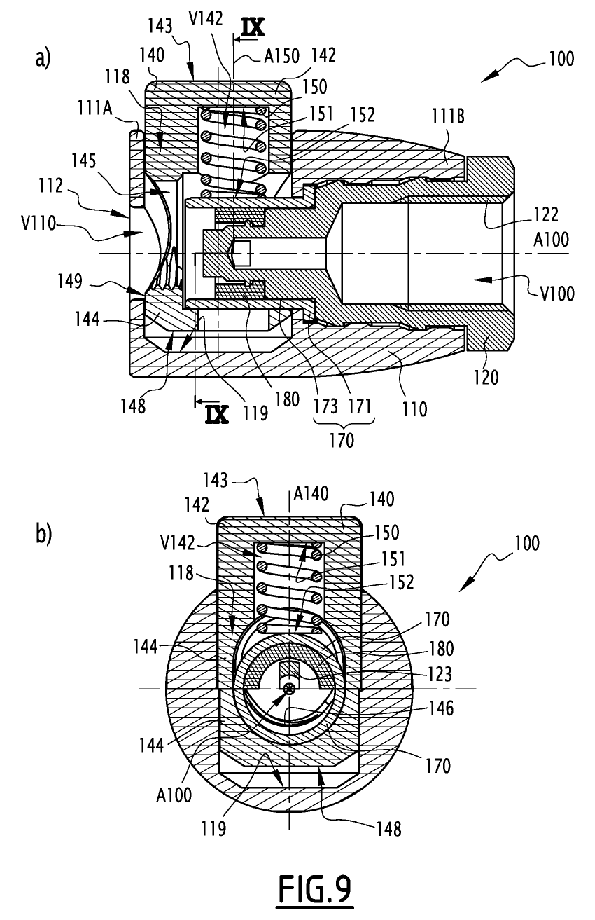

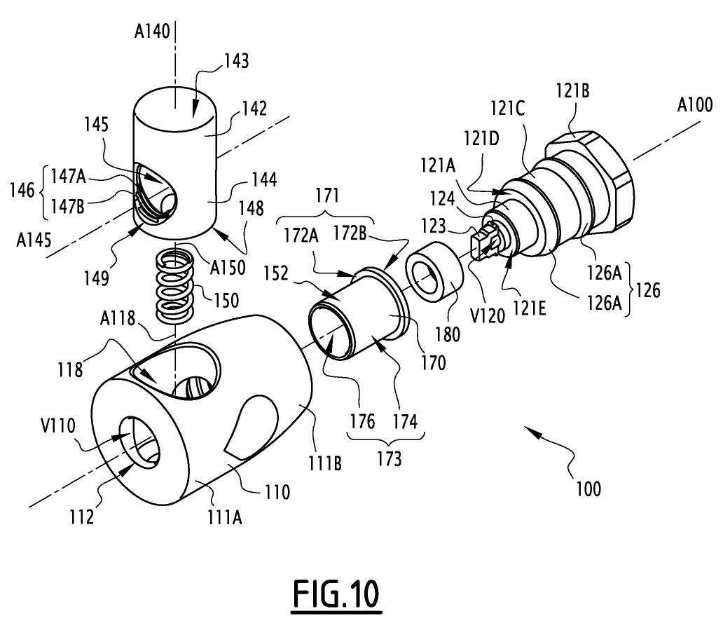

A third embodiment of the invention is shown in FIGS. 9 and 10.

As in the previous embodiments, the actuation portion 142 of the lock 140 is hollow and provides the primary support surface 151. One of the main differences of the third embodiment with the previous embodiments is that the secondary support surface 152 is here directly formed by the lock stop 170, as illustrated in FIG. 9.

The lock 140, and in particular the locking portion 144, here has a circular section, the housing 118 also having a circular section, easy to machine.

The through opening 145 opens, on the proximal side of the lock 140, through an oblong hole, through which the annular distal part 173 of the lock stop 170 penetrates. Thus, the lock stop 170 prevents rotational movements of the lock 140 relative to the main body 110 around the locking axis A118, while allowing movements between the locking position and the unlocking position.

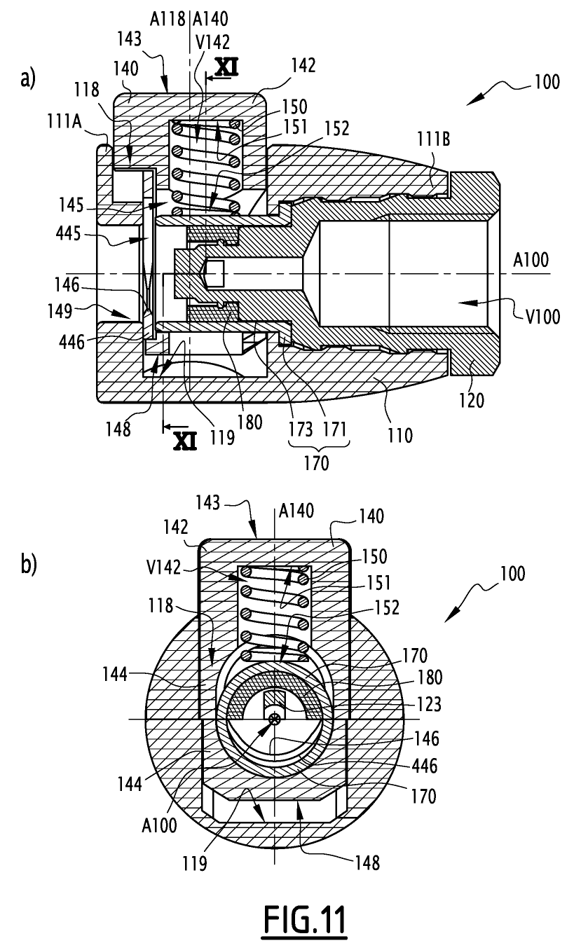

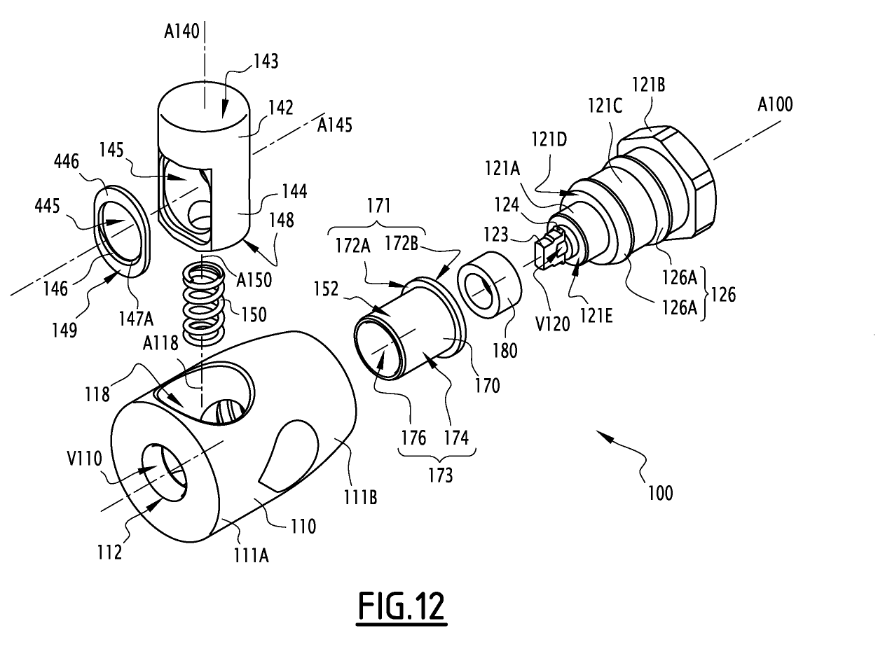

A fourth embodiment of the invention is shown in FIGS. 11 and 12. As in the third embodiment, the secondary support surface 152 is directly provided on the lock stop 170.

One of the main differences of the fourth embodiment with the other embodiments is that the lock 140 comprises an insert 446, which is made of metal, and which provides the retaining relief 146. The insert 446 is preferably made of steel. The insert 446 is integral with the lock 140, and in particular is assembled to the locking portion 144 of the lock 140, so that the insert 446 is moved with the rest of the lock 140 between the locking position and the unlocking position.

The insert 446 is here manufactured in a plate, which provides a passage ring 445 for the male fitting 10, the passage ring 445 forming a portion of the through opening 145 of the lock when the metal insert 446 is assembled to the rest of the lock 140. The insert 446 here comprises only the first tooth 147A, which is able to penetrate the threading of the distal part 14 of the male fitting 10 and which forms the retaining relief 146. This construction allows the use of a metal tooth more resistant to wear, while keeping the rest of the lock 140 made of plastic, i.e. lighter and more economical to manufacture in large series. The insert 446 also provides the stop face 149, which is also resistant to wear. In an unrepresented variant, the insert 446 comprises several teeth, which form the retaining relief 146. For example, the insert is made in a thicker plate.

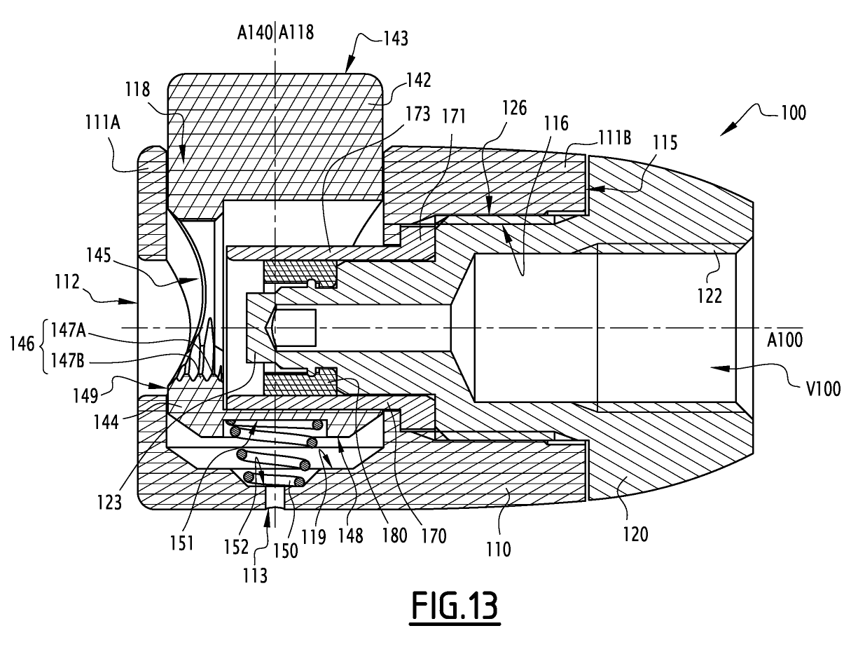

A fifth embodiment of the invention is shown in FIG. 13. One of the main differences of the fifth embodiment with the previous embodiments is that the return member 150 is placed opposite the actuation surface 143 of the lock 140 relative to the longitudinal axis A100.

In other words, the primary support surface 151 is not provided in a cavity of the actuation portion 142, but in the lower face 148 of the lock 140, while the secondary support face 152 is provided in the bottom 119 of the housing 118.

Furthermore, the adapter 120 is advantageously assembled to the main body 110 by screwing. In other words, the assembly means 126 are here formed by a threading provided on the external side of the intermediate part 121C, while the complementary assembly means 116 are formed by a threading, which is provided in the bore 114.

The female element 100 is thus removable, for example to clean the female element 100 and/or replace the annular seal 180.

In the fifth embodiment, the lock housing 118 is not blind but communicates with the outside of the main body 110 by means of the hole 113, which is here provided in the bottom 119 of the housing 118 of the main body 110. The hole 113 is here located opposite, relative to the main axis A100, the actuation surface 143 of the lock 140. Thanks to the hole 113, during the disconnection of the fluidic connector R, and more particularly when the pressurized fluid propagates into the housing 118, the action of the pressurized fluid on the lock 140, tending to return the lock 140 to the locking position, is limited. This prevents the operator from having to actuate the lock 140 several times to be able to disconnect the male fitting 10 from the female element 100.

The embodiments and variants mentioned above can be combined with each other to generate new embodiments of the invention.

This female element (100) for a fluidic connector (R) is designed to be connected to a Schrader-type male fitting (10), with a threaded tubular part (16). The female element (100) comprises a main body (110), which provides a distal mouth (112) for receiving the male fitting in an engaged position, and an adapter (120), which is intended to be secured to a pipeline, and which is assembled to the main body. A lock (140), which is received in a housing (118) provided radially in the main body, provides a through opening (145) intended to receive the male element in an engaged position. A lock stop (170) is guided in the main body (110) and extends in the housing (118) and in the opening (145) of the lock, so as to allow the movements of the lock between a locking position and an unlocking position, while preventing movements beyond the locking position.

What is claimed is:

1. A female element for a fluidic connector, the female element being designed to be connected to a Schrader-type male fitting, the male fitting comprising a tubular part with threading and housing a valve with a valve opening pin, the female element comprising:
a main body, which provides a first passage extending along a longitudinal axis, the main body comprising a distal portion and a proximal portion, which are aligned along the longitudinal axis, the first passage opening from the distal portion through a distal mouth, the main body being configured to receive the male fitting in the first passage through the distal mouth, the male fitting being in an engaged position relative to the female element,
the distal portion providing a housing, which extends from an outside of the main body along a locking axis radial to the longitudinal axis and which opens into the first passage,
an adapter, which is traversed by a second passage, and which comprises:
a proximal part, from which the second passage opens, and which comprises securing means, which are intended for the fluidic connection of the adapter to a pipeline,
an intermediate part, which comprises assembly means, by which the adapter is able to be assembled to the proximal portion of the main body, in an assembled configuration of the female element,
a distal part, which provides a pusher, the pusher extending, in the first passage, from the intermediate part towards the distal mouth when the female element is in an assembled configuration, the second passage opening from the pusher, so that when the adapter is assembled to the main body, the first passage and the second passage together form an internal channel of the female element, the pusher being able to push the pin of the male fitting when connecting the male fitting to the female element,
a lock, which is assembled to the distal portion, and which comprises:
a locking portion, which is received in the first passage and in which an opening is provided, which extends along an opening axis, and which defines a passage ring for the male fitting in an engaged position,
a retaining relief, which extends protruding into the opening, and which is able to penetrate the threading of the male fitting,
an actuation surface opposite the retaining relief relative to the opening axis,
the lock being received in the housing and being translatable relative to the main body along the locking axis, between:
a locking position, wherein, when the male fitting is received in the distal mouth in an engaged position, the retaining relief penetrates the threading of the male fitting to maintain the male fitting in an engaged position, and
an unlocking position, wherein the retaining relief releases the threading of the male fitting and does not oppose a withdrawal of the male fitting from the main body,
a return member, which is configured to return the lock from its unlocking position to its locking position,
an annular seal, which is arranged around the pusher in contact with an axial surface of the adapter, the axial surface being oriented towards the distal mouth and being carried by a plane perpendicular to the longitudinal axis, the annular seal being configured to cooperate with the tubular part of the male fitting in an engaged position to ensure sealing between the male fitting and the adapter,
wherein:
the female element also comprises a lock stop, the lock stop comprising:
an annular distal part, which is guided in the main body and which extends, along the longitudinal axis, in the housing of the main body and in the opening of the lock, the annular distal part cooperating with the locking portion to allow movements of the lock between the locking position and the unlocking position, while preventing movements beyond the locking position, and,
an internal bore, which surrounds the pusher, and which is intended to receive the tubular part of the male fitting,
the annular seal is placed between the internal bore of the lock stop and the pusher.

2. The female element according to claim 1, wherein:
the annular distal part of the lock stop extends, along the longitudinal axis, beyond the locking axis,
a diameter of the internal bore of the annular distal part is slightly larger than an external diameter of the tubular part of the male fitting.

3. The female element according to claim 1, wherein:
the lock provides an actuation surface, which is accessible from the outside of the female element, and which is intended for a user to move the lock from the locking position to the unlocking position, against the return member,
the lock housing communicates with the outside of the main body through an additional hole, which is provided through the main body, and which is located opposite the actuation surface relative to the longitudinal axis.

4. The female element according to claim 1, wherein:
the retaining relief comprises a first tooth, which reproduces a complementary threading portion of the threading of the tubular part of the male fitting, the first tooth extending over an angular portion greater than 60° centered on the opening axis.

5. The female element according to claim 4, wherein:
the retaining relief comprises, in addition to the first tooth, at least one second tooth, which is able to penetrate the threading of the tubular part of the male fitting jointly with the first tooth,
each second tooth reproduces a complementary threading portion of the threading of the tubular part, extending over an angular portion greater than 60° centered on the opening axis.

6. The female element according to claim 1, wherein:
the return member is located on a side of the actuation surface relative to the longitudinal axis and acts along a return axis, which is parallel to the locking axis and which is located between the locking axis and a rear of the main body.

7. The female element according to claim 1, wherein:
the lock provides a primary support surface, which extends generally along a plane orthogonal to the locking axis,
the main body provides a secondary support surface, which is located opposite the primary support surface,
the return member acts between the primary support surface of the lock and the secondary support surface.

8. The female element according to claim 6, wherein:
the lock provides a primary support surface, which extends generally along a plane orthogonal to the locking axis,
the female element comprises a support, which is received in the housing of the main body, the support being traversed by the annular distal part of the lock stop,
the support provides a secondary support surface, which is located opposite the primary support surface,
the return member acts between the primary support surface of the lock and the secondary support surface.

9. The female element according to claim 6, wherein:
the lock provides a primary support surface, which extends generally along a plane orthogonal to the locking axis,
the lock stop provides a secondary support surface, which is located opposite the primary support surface,
the return member acts between the primary support surface of the lock and the secondary support surface.

10. The female element according to claim 1, wherein:
the lock comprises an insert, which is made of metal and which, when the female element is in an assembled configuration, is integral with a rest of the lock and is arranged on a side of the distal mouth,
the insert provides a passage ring for the male fitting, the passage ring forming a portion of the lock opening,
the insert provides the retaining relief.

11. The female element according to claim 1, wherein:
the lock presents a stop face, which is oriented towards the distal mouth, and which is axially aligned with the internal bore of the lock stop when the lock is in the locking position,
the lock and the main body are designed so that when the lock is in its locking position and the male fitting is disconnected from the female element, the stop face opposes an introduction of the male fitting into a through opening of the lock.

12. A fluidic connector, comprising:
an example of the female element according to claim 1, and
a Schrader-type male fitting, the male fitting comprising a tubular part with threading and housing a valve with a valve opening pin,
wherein the male fitting is received in an engaged position in the internal channel of the female element.
